(19) United States
(12) Patent Application Publication
(10) Pub. No.: US 2019/0202640 A1
(43) Pub. Date: Jul. 4, 2019

(54) STRUCTURE OF MATERIAL FEEDING DEVICE

(71) Applicant: INSTITUTE OF NUCLEAR ENERGY RESEARCH, ATOMIC ENERGY COUNCIL, EXECUTIVE YUAN, R.O.C., Taoyuan City (TW)

(72) Inventors: YAU-PIN CHYOU, TAOYUAN CITY (TW); PO-CHUANG CHEN, TAOYUAN CITY (TW); SHR-CHIANG LIN, TAOYUAN CITY (TW); HSUAN-HUA CHANG, TAOYUAN CITY (TW); HSIU-MEI CHIU, TAOYUAN CITY (TW)

(21) Appl. No.: 16/021,307

(22) Filed: Jun. 28, 2018

(30) Foreign Application Priority Data
Dec. 29, 2017 (TW) 106146598

(51) Int. Cl. B65G 33/14; B65G 33/26; B65G 65/46

(52) U.S. Cl. CPC B65G 33/14; B65G 33/265; B65G 2201/042; B65G 2812/0566; B65G 65/46

(57) ABSTRACT

A structure of material feeding device is provided for avoiding material obstruction. In the material feeding system, a motor is adopted to drive material feeding member to spin in a material feeding silo. By using mechanical stirs, the blocking phenomenon of material is mitigated and thus achieving the purpose of avoiding material obstruction. According to the present invention, the first material feeding silo is connected with a first screw feeder for conveying materials. The first screw feeder is also connected to a second material feeding silo. The second material feeding silo is connected with a pipe. The pipe includes a first sealing valve and a second sealing valve for keeping the pipe sealed and thus avoiding contamination. Finally, the pipe is connected with a second screw feeder, which feeds materials into a vessel. Then a complete conveying line is formed for facilitating industrial production.

### FIELD OF THE INVENTION

The present invention relates generally to a structure of material feeding device, and particularly to a device which is capable of avoiding material obstruction while feeding material.

### BACKGROUND OF THE INVENTION

In the past, material obstruction usually occurs while discharging powder materials. This situation is caused by the balanced supporting force between the adhesion and friction force in a layer of powder and the pressure exerted from the above, just like an arch bridge redirecting horizontally the force from its own weight and the carrying weight thereon to the piers on both ends. When the small units push one another, the strength of the arch structure is enhanced. This means that even the supporting force from below of the powder layers is zero, the powder still can maintain static balance. It leads to blocking at the outlet or inside of a storage silo, so that material discharge becomes difficult. This phenomenon is called the bridging phenomenon.

The first reason for the bridging phenomenon is the mutual friction and restraint among material particles. In general, the bridging phenomenon occurs when the shape of particles is irregular, and the outlet diameter of silo is too small while does not exceed a certain multiple of the particle diameter. As particles flow in a storage silo, the protruding corners of materials rub against one another and form arch accumulation at the outlet, resulting in a completely stop of material flow. This phenomenon normally occurs in particles with low sphericity, such as gravel, coal, or coke. The solution is to enlarge the outlet size of storage silos or to apply impact at the outlet by vibrators, air explosion devices, or manual beats.

The second reason for the bridging phenomenon is the high viscosity of powder materials. Viscosity is the flow resistance inside viscous liquid and can be regarded as the friction of the fluid. Normally, viscosity originates from the mutual attraction among molecules, and will result in serious bridging phenomenon. The accumulation of tight arch is formed above the outlet of hopper silos, due to the increased water content of smaller particles by adsorbing humidity, or the consolidation of particles by the pressure from above. This situation occurs during the conveying process for tiny powder materials such as flour, pulverized coal, cement, medicine powder, and limestone. Thereby, the storage environment of silos, storage time, and powder characteristics should be taken into account for improving the design of silos.

The third reason for the bridging phenomenon is the water content. The higher the water content, the easier the serious bridging to be formed. Due to natural convection inside a silo, water will be accumulated on the sidewalls or in the surface among powder materials, which makes the powder materials to form cake then arch easily. This phenomenon usually happens in the portion of a silo where the diameter shrinks. The solution is to consider if the design of silo causes higher water content in the silo.

The fourth reason for the bridging phenomenon is the inadequate design of silo. First, if the angle of material discharging hopper is too small (less than 58°), the materials get support and the piling phenomenon occurs. The increased accumulation of materials leads to the bridging phenomenon. Secondly, if the diameter for material discharging is too narrow, materials tend to be obstructed. Thereby, the silo design should incorporate with an angle greater than the minimum value and a diameter wide enough for material discharging. The place where the diameter shrinks should not be too narrow, otherwise materials will accumulate.

Another phenomenon normally accompanying the bridging phenomenon is the rathole phenomenon, which is caused by penetrating discharge of powders. Powders are discharged along the tunnels above the outlet, leaving the sidewalls forming a stagnant region. If the powder materials are highly viscous, the powders in the stagnant zone will adhere to one another, preventing them from collapsing into the tunnels easily. Thereby, materials are usually accumulated above the outlet, as a result of the fourth reason as described above.

The bridging phenomenon and the accompanying rathole phenomenon are the most frequently encountered problems while discharging materials from silos, resulting in the powder supply to be unstable or even completely stopped. This can interfere the operational procedure and cause tremendous loss in industry. The bridging phenomenon prevails in the powder products, such as the agriculture, fertilizer, cement and mineral, pharmaceutical, power plant, powder metallurgy, and other industries. Most industries suffer severe bridging problems. Thereby, domestic industries are eager to solve the problem. Currently, although several solutions exist, but most of them still cannot meet practical and economical requirements. It is strongly urgent to develop an economical and effective arch breaking method.

### SUMMARY

An objective of the present invention is to provide a structure of material feeding device, which can avoid arch structures of materials. In the material feeding system, a material feeding member spins in a material feed silo. By using mechanical stirs, the bridging phenomenon of materials can be destroyed and thus achieving the purpose of preventing material obstruction.

Another objective of the present invention is to provide a structure of material feeding device, which is a conveying line by connecting two material feeding silos, two screw feeders, one pipe, and two sealing valves that is capable of preventing contamination on materials.

To achieve the above objectives, the present invention discloses a structure of material feeding device, which comprises a first material feeding silo and a material feeding member. The first material feeding silo includes a first opening at the bottom. The material feeding member includes a shaft with a plurality of material feeding blades. The material feeding member is disposed inside the first material feeding silo.

According to an embodiment of the present invention, the diameter of the first material feeding silo shrinks from the top to the bottom.

According to an embodiment of the present invention, the first material feeding silo includes a main part and a material feeding part. The material feeding part is disposed below the main part. The diameter of the material feeding part shrinks from the top to the bottom.

According to an embodiment of the present invention, the first material feeding silo includes a main part and a material feeding part. The material feeding part is disposed below the main part. The diameter of the material feeding part is smaller than the size of the main part.

According to an embodiment of the present invention, the material feeding member is disposed inside the material feeding part.

According to an embodiment of the present invention, the material feeding member is disposed at the junction between the material feeding part and the main part.

According to an embodiment of the present invention, the material feeding member is connected with a motor for driving the material feeding member to rotate.

According to an embodiment of the present invention, the plurality of material feeding blades can be a spiral material feeding blades.

According to an embodiment of the present invention, the structure of material feeding device further comprises a first screw feeder, a second material feeding silo, a pipe, and a second screw feeder. One end of the first screw feeder is connected with the first opening and hence connected with the first material feeding silo. The side surface of the second material feeding silo is connected with the other end of the first screw feeder. The second material feeding silo includes a second opening at the bottom. The pipe is connected with the second opening and hence connected with the second material feeding silo. The pipe includes a first sealing valve at the top and a second sealing valve at the bottom. One end of the second screw feeder is connected with the pipe and the downstream end of the second screw feeder is connected with a vessel.

### BRIEF DESCRIPTION OF THE DRAWINGS

FIG. 1 shows a schematic diagram of the structure according to the present invention;

FIG. 2 shows a structural schematic diagram according to the first embodiment of the present invention;

FIG. 3 shows a schematic diagram of another shape of the first material feeding silo;

FIG. 4 shows a schematic diagram of the spiral material feeding blades according to the first embodiment of the present invention;

FIG. 5 shows a schematic diagram of the material feeding member according to the second embodiment of the present invention; and

FIG. 6 shows a schematic diagram of the spiral material feeding blades according to the second embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The present invention provides a structure of material feeding device, which adopts a material feeding member spinning in the material feeding silo. By using mechanical stirs, the bridging phenomenon of materials can be destroyed. The conveying device is connecting two material feeding silos, two screw feeders, a pipe, and two sealing valves which can avoid contamination on materials. The present invention can improve various drawbacks in the prior art, and hence providing a more economical and practical structure to meet users' requirements.

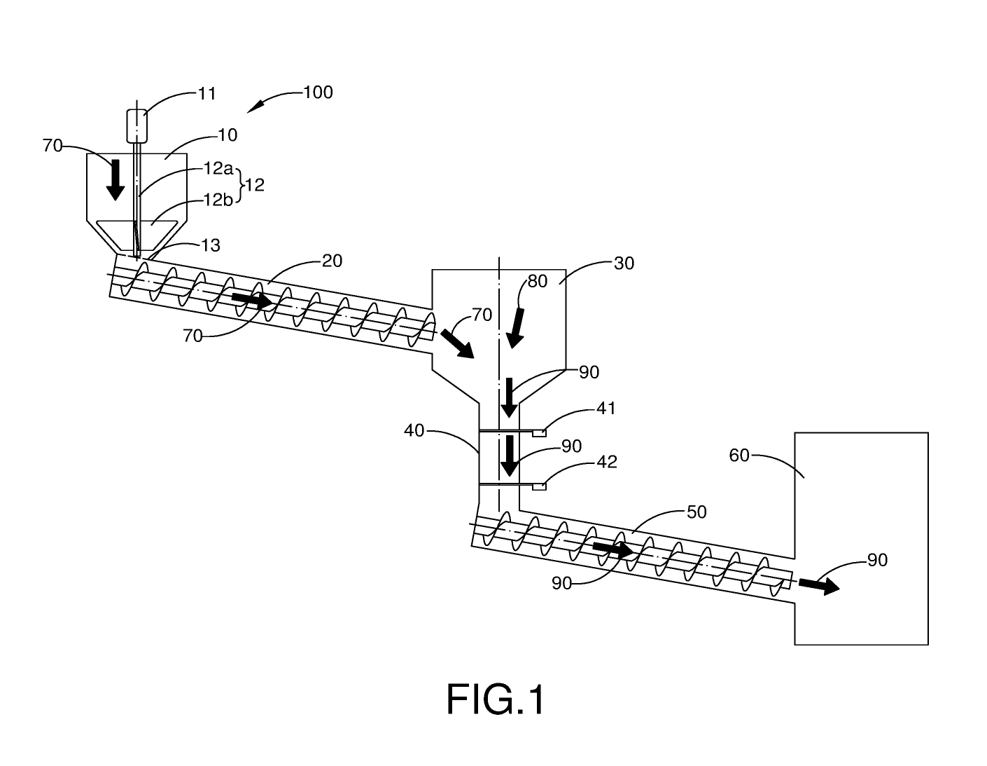

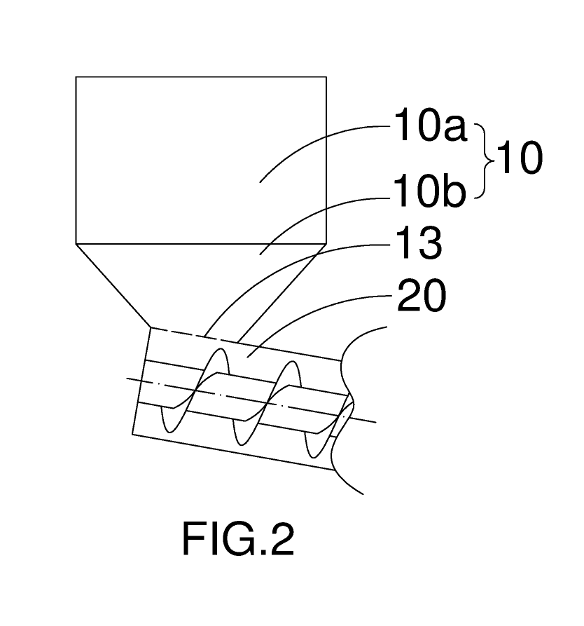

Please refer to FIG. 1 and FIG. 2. FIG. 1 shows a schematic diagram of the structure according to the present invention; FIG. 2 shows a structural schematic diagram according to the first embodiment of the present invention. As shown in the figures, a material feeding device 100 is a structure for avoiding material obstruction. It comprises a first material feeding silo 10, a material feeding member 12, a first screw feeder 20, a second material feeding silo 30, a pipe 40, a second screw feeder 50, and a vessel 60. Materials can be poured into the first and second material feeding silos 10, 30 for temporary storage. The material feeding member 12, the first screw feeder 20, and the second screw feeder 50 include spiral blades and a spin shaft for conveying materials. The pipe 40 includes a first sealing valve 41 and a second sealing valve 42 for ensuring tight sealing of materials and avoiding contamination.

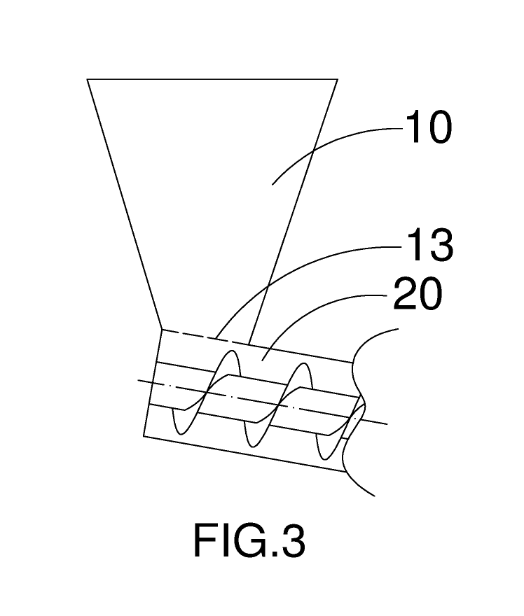

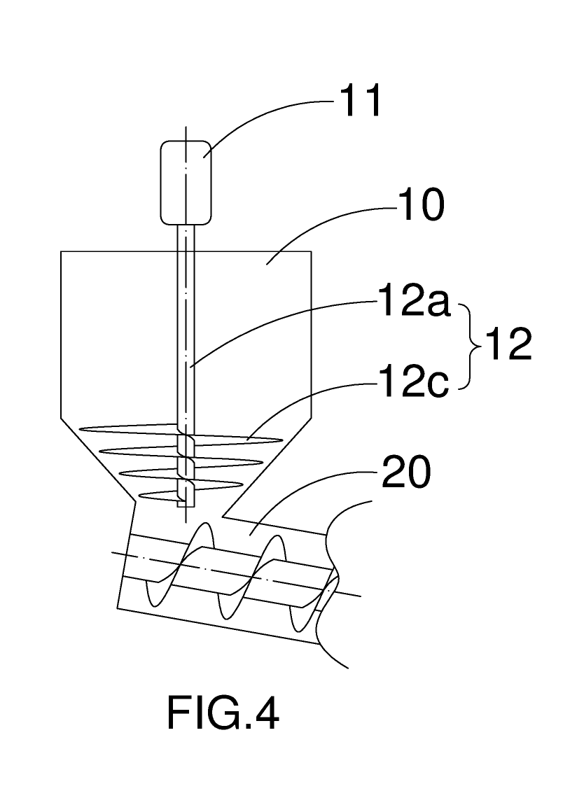

The shape of the first material feeding silo 10 is shown in FIG. 2. A main part 10a includes a diameter D1 and is barrel-shaped. The shape of the base blade can be, but not limited to, a circle or a rectangle. A material feeding part 10b is disposed below the main part 10a. The diameter of the material feeding part 10b shrinks from the top, which has a diameter D2, to the bottom, which has a diameter D3, and forming a diameter narrowing region 14. The diameter D3 is made to be smaller than the diameter D1, such that materials can be guided to slide downward. Please refer to FIG. 1. A material feeding member 12 is disposed inside the first material feeding silo 10. A motor 11 is adopted to drive the material feeding member 12 to spin. The material feeding member 12 includes a shaft 12a. A plurality of material feeding blades 12b are disposed at the end of the shaft 12a. The material feeding blades 12b are disposed at the diameter narrowing region 14 of the first material feeding silo 10 and located inside a first opening 13 at the bottom. Please refer to FIG. 3, which shows a schematic diagram of another shape of the first material feeding silo 10. As shown in the figure, the first material feeding silo 10 can be a cone-shaped structure with a diameter shrinking from D1 at the top to D3 at the bottom. Besides, please refer to FIG. 4, which shows a schematic diagram of the spiral of the material feeding blades according to the first embodiment of the present invention. As shown in the figure, alternatively, a spiral material feeding blades 12c can be disposed at the end of the shaft 12a.

The first screw feeder 20 is disposed at the first opening 13 of the first material feeding silo 10 and connected with the first material feeding silo 10. The first screw feeder 20 is connected with the side surface of the second material feeding silo 30. The second material feeding silo 30 includes a second opening 32, which is connected with the pipe 40. The pipe 40 includes the first sealing valve 41 at the top and the second sealing valve 42 at the bottom. The pipe 40 is connected with the second screw feeder 50. Finally, the second spiral material feeder 50 is connected with the vessel 60.

Next, pouring a first material 70 into the first material feeding silo 10. The material member 12 stirs mechanically for destroying bridging phenomenon of the first material 70. Then the first screw feeder 20 conveys the first material 70 to the second material feeding silo 30. Then pouring a second material 80 into the second material feeding silo 30 for mixing with the first material 70 and giving a mixed material 90. The mixed material 90 enters the pipe 40 from the first sealing valve 41 while the second sealing valve 42 is kept closed. After the mixed material 90 has reached a certain amount, the first sealing valve 41 is closed and the second sealing valve 42 is opened for conveying the mixed material 90 to the vessel 60 via the second screw feeder 50 and thus completing the conveying line of the present invention. In addition, the spin rates of the first and second screw feeders 20, 50 are both greater than the material feeding member 12. Thereby, the material feeding member 12 can control the spin rate of a plurality of material feeding blades 12b or spiral material feeding blades 12c by using the motor 11 and hence achieving the purpose of controlling material feeding rate.

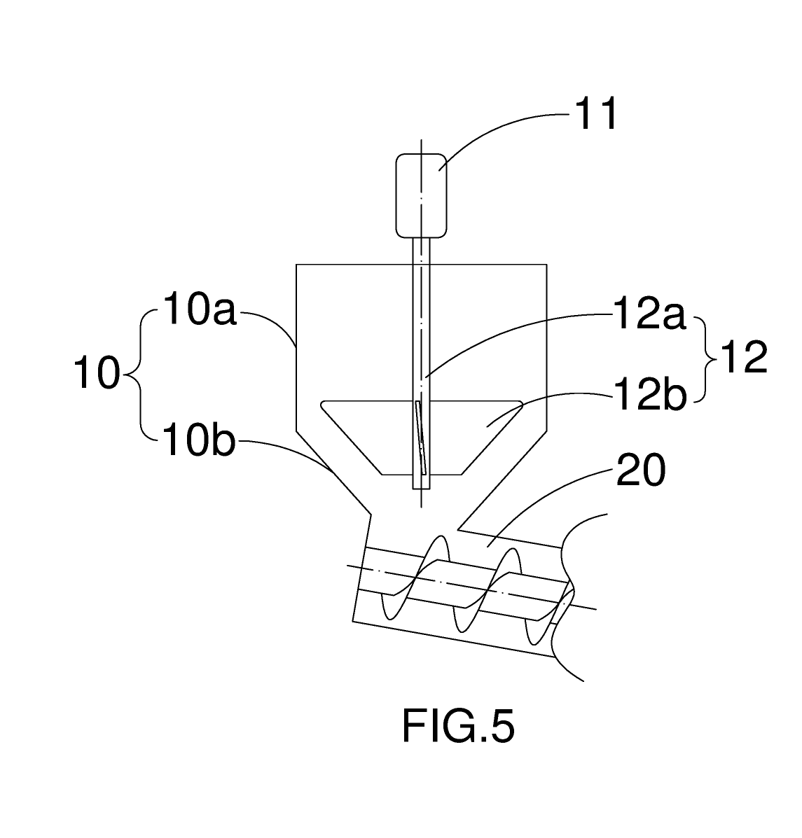

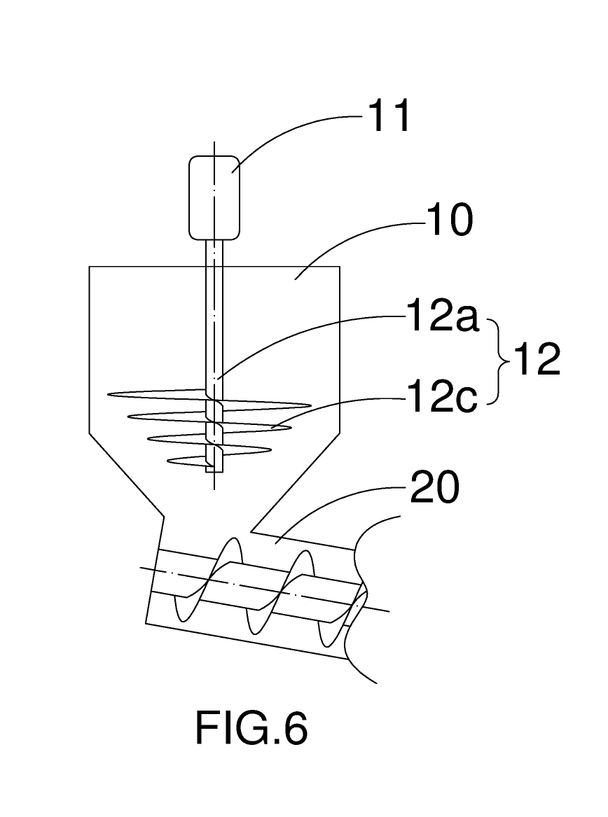

Please refer to FIG. 5, which shows a schematic diagram of the material feeding member according to the second embodiment of the present invention. As shown in the figure, a material feeding member 12 is disposed inside the first material feeding silo 10. A motor 11 is adopted for driving the material feeding member 12 to spin. The material feeding member 12 includes a shaft 12a. A plurality of material feeding blades 12b are disposed at the end of the shaft 12a and at the junction 10c between a main part 10a and a material feeding part 10b of the first material feeding silo 10. Besides, please refer to FIG. 6, which shows a schematic diagram of the spiral material feeding blades according to the second embodiment of the present invention. As shown in the figure, alternatively, a spiral material feeding blades 12c can be disposed at the end of the shaft 12a. The locations and operations of the other components according to the second embodiment of the present invention are identical to those according to the first embodiment. Hence, the details will not be described again here.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A structure of material feeding device, comprising:
a first material feeding silo, having a first opening at the bottom; and
a material feeding member, including a shaft and a plurality of material feeding blades disposed at the end of said shaft, and the material feeding member is disposed inside said first material feeding silo.

2. The structure of material feeding device of claim 1, wherein the diameter of said first material feeding silo shrinks from the top to the bottom.

3. The structure of material feeding device of claim 1, wherein said first material feeding silo includes a main part and a material feeding part; said material feeding part is disposed below the main part; and the diameter of said material feeding part shrinks from the top to the bottom.

4. The structure of material feeding device of claim 1, wherein said first material feeding silo includes a main part and a material feeding part; said material feeding part is disposed below the main part; and the diameter of said material feeding part is smaller than the diameter of said main part.

5. The structure of material feeding device of claim 1, wherein said material feeding member is disposed inside said material feeding part.

6. The structure of material feeding device of claim 1, wherein said material feeding member is disposed at the junction between said material feeding part and said main part.

7. The structure of material feeding device of claim 1, wherein said material feeding member is connected with a motor for driving said material feeding member to spin.

8. The structure of material feeding device of claim 1, wherein said plurality of material feeding blades can be a spiral material feeding blades.

9. The structure of material feeding device of claim 1, and further comprising:
a first screw feeder, having one end connected with said first opening for connecting to said first material feeding silo;
a second material feeding silo, having a side surface connected with the other end of said first screw feeder, and having a second opening at the bottom;
a pipe, connected with said second opening for connecting to said second material feeding silo, having a first sealing valve at the top, and having a second sealing valve at the bottom; and
a second screw feeder, having one end connected with said pipe, and having the downstream end connected with a vessel.
